(19) United States
(12) Patent Application Publication
(10) Pub. No.: US 2012/0188500 A1
(43) Pub. Date: Jul. 26, 2012

(54) EYEGLASSES HAVING TWO REMOVABLE LENS UNITS

(75) Inventor: Shun-Tien Yang, Tainan City (TW)

(73) Assignee: ALL-LOGIC INT. CO., LTD., Tainan City (TW)

(21) Appl. No.: 13/348,179

(22) Filed: Jan. 11, 2012

(30) Foreign Application Priority Data
Jan. 20, 2011 (TW) 100201310

(51) Int. Cl. G02C 1/00

(52) U.S. Cl. 351/83

(57) ABSTRACT

Eyeglasses include a frame assembly and two lens units. The frame assembly includes two eyeglass frames and two temples. Each of the eyeglass frames includes a frame body, an open-ended slide slot formed in the eyeglass frame body, and a retaining hook extending from the frame body. The lens units are mounted respectively and removably to the eyeglass frames. Each of the lens units includes an outer frame, a projecting strip extending from the outer frame and engaged within the slide slot in a corresponding one of the eyeglass frames, and a positioning hole formed in the outer frame and permitting the retaining hook to be engaged therein so as to prevent removal of the projecting strip from the slide slot.

### CROSS-REFERENCE TO RELATED APPLICATION

This application claims priority of Taiwanese Application No.100201310, filed on Jan. 20, 2011.

### BACKGROUND OF THE INVENTION

1. Field of the Invention

This invention relates to eyeglasses, and more particularly to eyeglasses having two removable lens units.

2. Description of the Related Art

Conventional eyeglasses have been designed to include two removable lenses. Some fasteners or retainers, however, are incorporated in the conventional eyeglasses in order to allow for removal and reassemble of the lenses with respect to an eyeglass frame assembly, which leads to complicated construction and a substantial increase in the total weight of the conventional eyeglasses. Moreover, during removal and reassembly of the lenses, the fasteners or retainers must be removed from and subsequently mounted back to the eyeglass frame assembly one at a time, thereby resulting in inconvenience during use of the conventional eyeglasses.

### SUMMARY OF THE INVENTION

An object of this invention is to provide eyeglasses that include two removable lens units and that have a simple structure.

Another object of this invention is to provide eyeglasses including two removable lens units that are convenient to replace.

According to this invention, eyeglasses include a frame assembly and two lens units. The frame assembly includes two eyeglass frames and two temples. Each of the eyeglass frames includes a frame body, an open-ended slide slot formed in the eyeglass frame body, and a retaining hook extending from the frame body. The lens units are mounted respectively and removably to the eyeglass frames. Each of the lens units includes an outer frame, a projecting strip extending from the outer frame and engaged within the slide slot in a corresponding one of the eyeglass frames, and a positioning hole formed in the outer frame and permitting the retaining hook to be engaged therein so as to prevent removal of the projecting strip from the slide slot.

By engaging the projecting strip with the slide slot and engaging the retaining hook with the positioning hole, the lens units can be retained effectively on the frame assembly. Such a connection is simple in structure, and is convenient to operate.

### BRIEF DESCRIPTION OF THE DRAWINGS

These and other features and advantages of this invention will become apparent in the following detailed description of a preferred embodiment of this invention, with reference to the accompanying drawings, in which:

FIG. 1 is a perspective view of the preferred embodiment of eyeglasses according to this invention;

FIG. 2 is a fragmentary partly exploded perspective view of the preferred embodiment, illustrating a connection between a frame assembly and a lens unit;

FIG. 3 is a fragmentary sectional view of the preferred embodiment, illustrating the connection between the frame assembly and the lens unit; and

FIG. 4 is a fragmentary top view of the preferred embodiment, illustrating that a protrusion of the frame assembly is engaged within a retaining groove of the lens unit.

### DETAILED DESCRIPTION OF THE PREFERRED EMBODIMENT

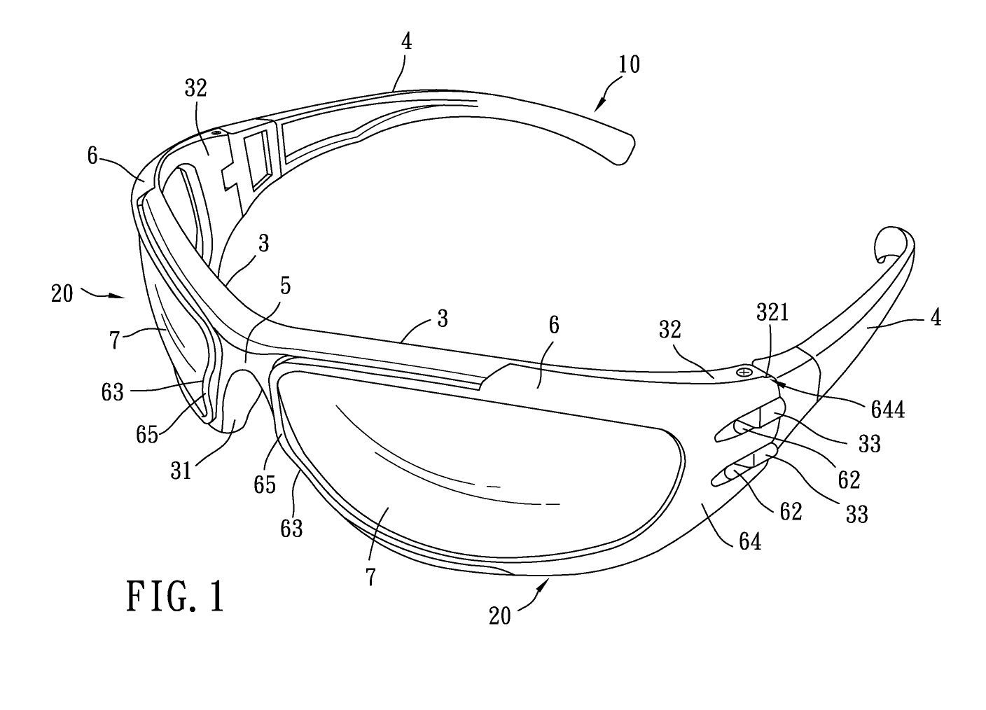

Referring to FIGS. 1, 2, and 3, the preferred embodiment of eyeglasses according to this invention is worn on the face of a wearer, and includes a frame assembly 10 that is bilaterally symmetric, and two lens units 20 mounted removably to the frame assembly 10.

The frame assembly 10 includes two eyeglass frames 3 arranged along a left-to-right direction, and a bridge 5 interconnecting the eyeglass frames 3, and two temples 4 connected respectively and pivotally to the eyeglass frames 3. In this embodiment, the eyeglass frames 3 and the bridge 5 are manufactured to form a one-piece molded structure.

Each of the eyeglass frames 3 is loop-shaped, and includes a frame body 30 having a proximate section 31 proximate to the other of the eyeglass frames 3 and a distal section 32 distal from the other of the eyeglass frames 3, an open-ended slide slot 34 formed in the proximate section 31 of the frame body 30, two retaining hooks 33 extending from the distal section 32 of the frame body 30 and spaced apart from each other along a vertical direction, and two retaining spaces 35 defined respectively by the retaining hooks 33. One of the eyeglass frames 3, one of the temples 4, and one of the lens units 20 at the same side will be described hereinafter.

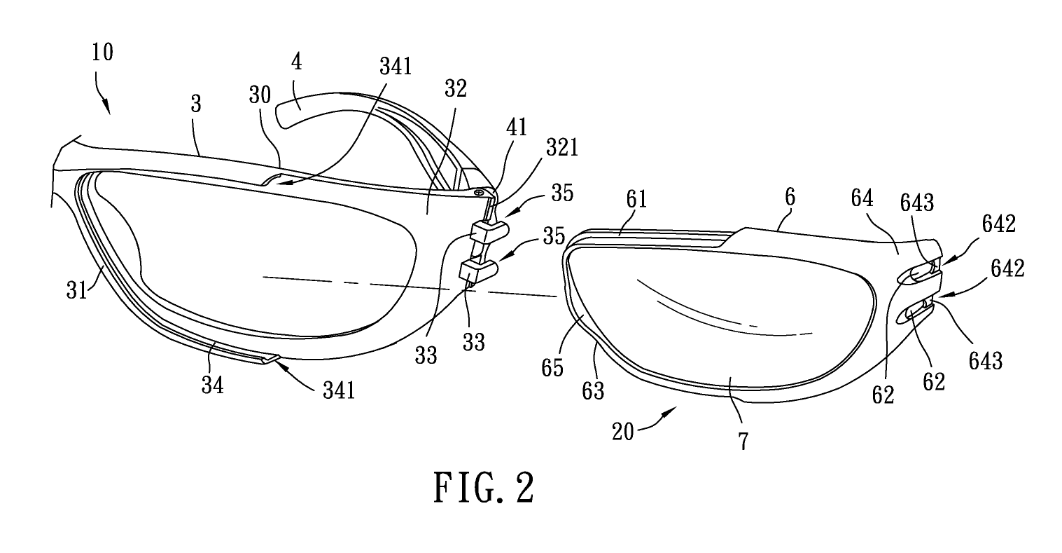

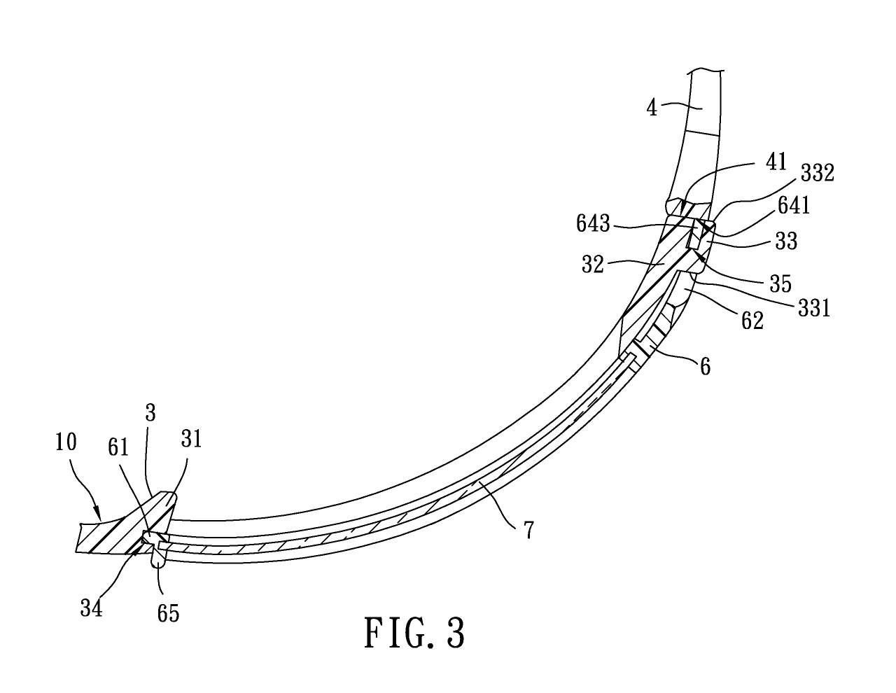

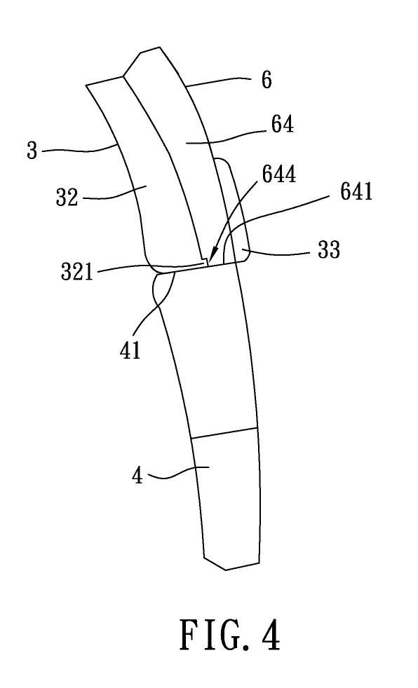

With further reference to FIG. 4, the distal section 32 of the frame body 30 has two protrusions 321 (only an upper one is shown in FIG. 2) extending respectively from upper and lower ends thereof and disposed in proximity to the temple 4. The slide slot 34 is disposed at a front side of the proximate section 31 of the frame body 30, extends along a U-shaped path, and has open upper and lower ends 341. Each of the retaining hooks 33 is L-shaped, and has a first straight rod portion 331 (see FIG. 3) extending from the distal section 32, and a second straight rod portion 332 (see FIG. 3) having an end extending perpendicularly from an end of the first straight rod portion 331. The L-shaped retaining hooks 33 are open in a direction away from the proximate section 31.

The temple 4 is mounted removably to the eyeglass frame 3, has a downwardly bent rear end, and is pivotable relative to the eyeglass frame 3 between a folded position shown in FIG. 2 and an unfolded position shown in FIG. 1. At the folded position, the temple 4 extends along the left-to-right direction. At the unfolded position, the temple 4 extends along a front-to-rear direction, and an end surface 41 of temple 4 abuts against the second straight rod portions 332 of the retaining hooks 33 for sealing the retaining spaces 35 of the retaining hooks 33.

The lens unit 20 is mounted to the eyeglass frame 3, and includes a loop-shaped outer frame 6, and a lens 7 inserted within the outer frame 6. The shape of the outer frame 6 corresponds to that of the eyeglass frame 3. The outer frame 6 has an inner side section 63 aligned with the proximate section 31 of the eyeglass frame 3, an outer side section 64 aligned with the distal section 32 of the eyeglass frame 3, and a force-applying wall 65 extending forwardly from the inner side section 63 for manual operation. The lens unit 20 further includes a projecting strip 61 extending from the inner side section 63 of the outer frame 6, and two positioning holes 62 formed through the outer side section 64 and spaced apart from each other along the vertical direction. The height of the force-applying wall 65 in the front-to-rear direction is not uniform. The projecting strip 61 is U-shaped, and is engaged within the slide slot 34 of the eyeglass frame 3. The positioning holes 62 are elongated, and permit the retaining hooks 33 to be engaged respectively therein, in such a manner that the first straight rod portion 331 extends through the corresponding positioning hole 62. The outer side section 64 has an end surface 641 for contact with the end surface 41 of the temple 4, a front surface formed with two spaced-apart recesses 642 arranged along the vertical direction, two engaging portions 643 disposed at a rear end of the outer side section 64, and two retaining grooves 644 (only an upper one is shown in FIG. 1) formed respectively in upper and lower ends of a rear surface of the outer side section 64. The recesses 642 are in spatial communication with the positioning holes 62, respectively. Each of the engaging portions 643 acts as a bottom wall surface defining the corresponding recess 642, and defines a rear end of the corresponding positioning hole 62. The protrusions 321 are fitted within the retaining grooves 644, respectively. In this embodiment, the outer frame 6 is unitary.

During assembly, the temple 4 is first pivoted to the folded position to open the retaining spaces 35 of the retaining hooks 33. Next, the projecting strip 61 is inserted into the slide slot 34. When the projecting strip 61 is moved along the slide slot 34 to align the positioning holes 62 with the retaining hooks 33, respectively, the retaining hooks 33 are moved respectively through the positioning holes 62 until the second straight rod portions 332 come into contact with the engaging portions 643, respectively. At this time, the projecting strip 61 is further moved along the slide slot 34 until it is engaged entirely within the slide slot 34. As a result, the engaging portions 643 are fitted within the retaining spaces 35, respectively, and are disposed between the distal section 32 and the retaining hooks 33, and the protrusions 321 are fitted respectively within the retaining grooves 644. Finally, the temple 4 is pivoted to the unfolded position, so that the end surface 41 of the temple 4 abuts against the end surface 641 of the lens unit 20 and the second straight rod portions 332 of the retaining hooks 33, thereby confining the engaging portions 643 within the retaining hooks 33, respectively, so as to prevent removal of the lens unit 20 from the eyeglass frame 3.

When removal of the lens unit 20 is desired, it is only necessary to apply a force on the force-applying wall 65 to remove the projecting strip 61 from the slide slot 34 and remove the retaining hooks 33 from the positioning holes 62, respectively. Since the force-applying wall 65 extends forwardly from the inner side section 63, it is convenient to operate.

As such, the lens unit 20 can be replaced with relative ease.

Alternatively, the number of the retaining hooks 33 of the eyeglass frame 3 and the positioning holes 62 in the lens unit 20 may be changed. For example, the eyeglass frame 3 includes only one retaining hook 33, the width of which is increased, and the lens unit 20 includes only one positioning hole 62.

With this invention thus explained, it is apparent that numerous modifications and variations can be made without departing from the scope and spirit of this invention. It is therefore intended that this invention be limited only as indicated by the appended claims.

I claim:

1. Eyeglasses comprising:
a frame assembly including two eyeglass frames interconnected along a left-to-right direction, and two temples connected respectively and pivotally to said eyeglass frames, each of said eyeglass frames including a frame body, an open-ended slide slot formed in said eyeglass frame body, and a retaining hook extending from said frame body; and
two lens units mounted respectively and removably to said eyeglass frames, each of said lens units including an outer frame, a projecting strip extending from said outer frame and engaged within said slide slot in a corresponding one of said eyeglass frames, and a positioning hole formed in said outer frame and permitting said retaining hook to be engaged therein so as to prevent removal of said projecting strip from said slide slot, thereby preventing removal of a corresponding one of said lens units from the corresponding one of said eyeglass frames.

2. The eyeglasses as claimed in claim 1, wherein said frame body of each of said eyeglass frames has a proximate section proximate to the other of said eyeglass frames and formed with said slide slot, and a distal section distal from the other of said eyeglass frames and formed with said retaining hook, each of said temples being pivotable relative to said eyeglass frames between a folded position and an unfolded position and extending along a left-to-right direction when at the folded position and along a front-to-rear direction when at the unfolded position, each of said temples having an end surface that is disposed in proximate to the corresponding one of said eyeglass frames and that abuts against said outer frame of the corresponding one of said lens units when at the unfolded position.

3. The eyeglasses as claimed in claim 2, wherein said outer frame of each of said lens units has an inner side section aligned with said proximate section of the corresponding one of said eyeglass frames and formed with said projecting strip, and an outer side section aligned with said distal section of the corresponding one of said eyeglass frames, and a force-applying wall extending forwardly from said inner side section for manual operation.

4. The eyeglasses as claimed in claim 3, wherein said positioning hole in each of said lens units is formed through said outer side section of said outer frame of the corresponding one of said lens units, said outer side section of each of said lens units having an end surface for contact with said end surface of a corresponding one of said temples.

5. The eyeglasses as claimed in claim 4, wherein said outer side section of each of said lens units further has a front surface formed with a recess in spatial communication with said positioning hole, said retaining hook of each of said eyeglass frames being L-shaped and having first straight rod section extending through said positioning hole in the corresponding one of said lens units, and a second straight rod section having an end extending perpendicularly from an end of said first straight rod section and fitted within said recess in said outer side section of the corresponding one of said lens units.

6. The eyeglasses as claimed in claim 5, wherein said distal section of each of said eyeglass frames is formed with two protrusions disposed respectively at upper and lower ends thereof, said outer side section of each of said lens units having two retaining grooves permitting said protrusions of the corresponding one of said eyeglass frames to be fitted respectively therein.
